(19) United States
(12) Patent Application Publication
(10) Pub. No.: US 2012/0231282 A1
(43) Pub. Date: Sep. 13, 2012

(54) INORGANIC BOARD AND INORGANIC BOARD PRODUCTION METHOD

(76) Inventor: Tadashi SUGITA, Nagoya-shi (JP)

(21) Appl. No.: 13/043,561

(22) Filed: Mar. 9, 2011

(51) Int. Cl. B32B 19/00; B32B 13/00; B32B 37/16

(52) U.S. Cl. 428/454; 156/242; 428/446

(57) ABSTRACT

The present invention provides an inorganic board having excellent wind pressure resistance and long-term durability, and a production method of such an inorganic board.

An inorganic board is obtained by laminating layers comprising a cement, a siliceous material and a woody reinforcement, and has a specific gravity ranging from 1.5 to 2.0; a dimensional change rate upon ten-day moisture desorption at 80° C. of no greater than 0.1%; a dimensional change rate upon seven-day moisture absorption of no greater than 0.1%; a seven-day dimensional change rate, in an environment having a carbon dioxide concentration of 5%, of no greater than 0.1%; and a flexural strength of not lower than 20 N/mm². A method for producing an inorganic board includes a step of producing raw material slurry comprising a cement, a siliceous material and a woody reinforcement; a step of producing laminated mat by laminating sheets formed by dewatering the obtained raw material slurry; and a step of pressing the laminated mat at a pressure not lower than 50 kg/cm², and curing the laminated mat at 170 to 200° C. in an autoclave.

### BACKGROUND OF THE INVENTION

1. Field of the Invention

The present invention relates to an inorganic board suitable for building boards, and to a method for producing such an inorganic board.

2. Description of the Related Art

Conventional inorganic boards have, as main components, a hydraulic inorganic powder such as a cement or the like, and a woody reinforcement such as wood pulp fibers. For instance, Japanese Patent Application Publication No. H09-227200 discloses a method for producing an inorganic board wherein the method involves adding an alkali-treated inorganic hollow filler to a mixture having, as a main component, a cement and a fibrous material, to prepare thereby a slurry; subjecting then the slurry to sheet-forming and dewatering, to yield a mat that is laminated in a plurality of layers; and molding, curing and hardening the laminated mat. Such an inorganic board has excellent characteristics in terms of, for instance, flexural strength. Therefore, the inorganic board can be used as a building board in, for instance, inner wall materials and outer siding materials in houses.

In recent years, the use of inorganic boards has expanded, and studies have been conducted on the use of such inorganic boards in the construction of, for instance, middle-rise buildings. However, middle-rise buildings reach heights of 36 m, where wind pressure is substantial. The wind pressure resistance of inorganic boards used in the construction of the building must be enhanced accordingly. In recent years, moreover, long-term durability of requirements in houses has become more demanding, and hence the inorganic boards must exhibit yet better long-term durability. The long-term durability denotes little physical deterioration and dimensional changes even after a long period of more than 10 years.

### SUMMARY OF THE INVENTION

The problem of the present invention, therefore, is to provide an inorganic board having excellent wind pressure resistance and long-term durability, and to provide a production method of such an inorganic board.

The inorganic board of the present invention is obtained by laminating layers comprising a cement, a siliceous material and a woody reinforcement, and has a specific gravity ranging from 1.5 to 2.0; a dimensional change rate upon ten-day moisture desorption at 80° C. of no greater than 0.1%; a dimensional change rate upon seven-day moisture absorption of no greater than 0.1%; a seven-day dimensional change rate, in an environment having a carbon dioxide concentration of 5%, of no greater than 0.1%; and a flexural strength of not lower than 20 N/mm². Herein, the flexural strength is a value measured in accordance with JIS A 1408. A flexural strength of 20 N/mm² or greater makes for excellent wind pressure resistance, enough for passing a wind pressure resistance test under harsh conditions, namely a height of 36 m and a wind pressure of 46 m/minute. The moisture desorption dimensional change rate is a value arrived at by bringing a specimen to an equilibrium state in a constant-temperature constant-humidity chamber at 20° C. and 60% humidity, measuring then the length (l₁) of the specimen, placing the specimen in a dryer at 80° C., and after 10 days, removing the specimen from the dryer, measuring again the length (l₂) of the specimen, and dividing (l₁-l₂) by l₂ and multiplying by 100. The moisture absorption dimensional change rate is a value obtained by bringing a specimen to an equilibrium state in a constant-temperature constant-humidity chamber at 20° C. and 60% humidity, measuring then the length (l₃) of the specimen, immersing the specimen in water, and after seven days, removing the specimen from the water, wiping off the water adhered to the surface using a cloth, measuring again the length (l₄) of the specimen, and dividing (l₄-l₃) by l₃ and multiplying by 100. The seven-day dimensional change rate in an environment having a carbon dioxide concentration of 5% is a value arrived at by bringing a specimen to an equilibrium state in a constant-temperature constant-humidity chamber at 20° C. and 60% humidity, measuring then the length (l₅) of the specimen, exposing thereafter the specimen to an environment having a carbon dioxide concentration of 5%, for 7 days, measuring then again the length (l₆) of the specimen, and dividing (l₅-l₆) by l₅ and multiplying by 100. The dimensional change rate upon ten-day moisture desorption at 80° C. denotes the degree of dimensional change derived from moisture desorption. The dimensional change rate upon seven-day moisture absorption denotes the degree of dimensional change due to moisture absorption. The seven-day dimensional change rate in an environment having a carbon dioxide concentration of 5% denotes the degree of dimensional change due to carbonation. Inorganic boards having values no greater than 0.1% for the foregoing change rates exhibit little deterioration over time, and boast excellent dimensional stability. As a result, the properties of the boards are little impaired even over long periods of time after construction. Such boards are thus useful as building boards having long-term durability. In the inorganic board of the present invention, preferably, a weight ratio of the content of the cement and the siliceous material ranges from 35:65 to 45:55, and the content of the woody reinforcement ranges from 7 to 10 wt %, since in that case the inorganic board exhibits particularly superior flexural strength, deflection and dimensional change rate. Preferably, the woody reinforcement is needle-leaves-tree pulp, or needle-leaves-tree pulp and used paper, since in that case the inorganic board can be imparted with appropriate deflection. Preferably, the inorganic board comprises 3 to 5 wt % of mica, since dimensional stability is yet better in that case. Preferably, thickness of the inorganic board is 6 to 25 mm, since transport ability and construction ability are yet better in that case.

The present invention provides also a method for producing inorganic board. The method for producing inorganic board of the present invention includes a step of producing raw material slurry comprising a cement, a siliceous material and a woody reinforcement; a step of producing laminated mat by laminating sheets formed by dewatering the obtained raw material slurry; and a step of pressing and curing the laminated mat. The press pressure in the pressing and curing step is not lower than 50 kg/cm², and curing is performed at 170 to 200° C. in an autoclave. An inorganic board having example flexural strength and long-term durability can be produced as a result. Preferably, in the step of producing laminated mat, the laminated mat is produced by laminating sheets obtained by pressure-dewatering the raw material slurry. In the step of producing raw material slurry, preferably, a weight ratio of the cement and the siliceous material in the raw material slurry ranges from 35:65 to 45:55, and the content of the woody reinforcement ranges from 7 to 10 wt % with respect to solids of the raw material slurry, since in that case the obtained inorganic board boasts particularly superior flexural strength, deflection and dimensional change rate. Preferably, the woody reinforcement in the raw material slurry used in the step of producing raw material slurry is a needle-leaves-tree pulp, or a needle-leaves-tree pulp and used paper, since in that case the inorganic board can be imparted with appropriate deflection. In the step of producing raw material slurry, preferably, 3 to 5 wt % of mica, on a solids basis, is incorporated into the raw material slurry, since dimensional stability is yet better in that case. Preferably, thickness of the inorganic board is 6 to 25 mm, since productivity and manufacturing costs are yet better in that case.

The present invention succeeds in providing an inorganic board having excellent wind pressure resistance and long-term durability, and a production method of such an inorganic board.

### DESCRIPTION OF THE PREFERRED EMBODIMENTS

Embodiments of the present invention are explained in detail below.

The inorganic board of the present invention is laminated of a plurality of layers comprising a cement, a siliceous material and a woody reinforcement.

Examples of the cement include, for instance, Portland cement, high early-strength cement, alumina cement, fly ash cement, blast-furnace slag cement, silica cement, white cement or the like. In the present invention there may be contained one type alone, or two or more types, of any of the foregoing materials.

Examples of the siliceous material include, for instance, silica sand, silica stone powder, silica flour, silica fume, fly ash, blast furnace slag, Shirasu balloons, perlite, diatomaceous earth and the like. In the present invention there maybe contained one type alone, or two or more types, of any of the foregoing materials.

Examples of the woody reinforcement include, for instance, used paper, needle-leaves-tree unbleached kraft pulp (NUKP), needle-leaves-tree bleached kraft pulp (NBKP), laubholz unbleached kraft pulp (LUKP), laubholz bleached kraft pulp (LBKP) and the like. In the present invention there may be contained one type alone, or two or more types, of any of the foregoing materials. Preferably, a woody reinforcement having a Canadian freeness ranging from 300 to 600 ml, refined using a beating machine such as a disc refiner or the like, is used herein, since such a woody reinforcement allows enhancing properties such as strength.

Mica can also be used as a raw material other than the above-described ones. Preferably, the mica is flake-like mica having an average particle size ranging from 200 to 700 μm and an aspect ratio ranging from 60 to 100. Mica is preferred since it ordinarily has a lamellar structure, is not hygroscopic, and is a stiff, highly elastic material, whereby the dimensional stability of the inorganic board is greatly enhanced.

A cement composition may also be used. As the cement composition there can be used, for instance, defective inorganic boards before hardening or defective inorganic boards after hardening, produced in a production process, as well as scraps, waste and the like of inorganic boards gathered at a construction site. All such materials are used after pulverization, in an impact mill and/or abrasion mill, to an average particle size of 50 to 150 μm. Using the above cement composition allows reducing manufacturing costs while reducing industrial waste.

Other raw materials of the inorganic board include, for instance, hardening accelerators such as calcium chloride, magnesium chloride, potassium sulfate, calcium sulfate, magnesium sulfate, aluminum sulfate, sodium aluminate, potassium aluminate, calcium formate, calcium acetate, calcium acrylate, water glass or the like; mineral powders such as bentonite, vermiculite or the like; waterproofing agents such as natural and synthetic waxes, paraffin, succinic acid, silicone or metal salts of higher fatty acids; water-repelling agents; plastic foam such as foamed thermoplastic plastic beads; chemical fibers such as nylon, polyvinyl alcohol fibers, polyester fibers, polypropylene fibers, acrylic fibers, polyurethane fibers, glass fibers or the like; an aqueous paste of polyvinyl alcohol, carboxymethylcellulose or the like; or a reinforcing agent of a synthetic resin emulsion such as an acrylic resin emulsion, a styrene-butadiene latex or the like.

The inorganic board of the present invention is laminated of a plurality of layers comprising a cement, a siliceous material and a woody reinforcement, wherein the inorganic board has a specific gravity ranging from 1.5 to 2.0, a dimensional change rate upon ten-day moisture desorption at 80° C. of no greater than 0.1%, a dimensional change rate upon seven-day moisture absorption of no greater than 0.1%, a seven-day dimensional change rate, in an environment having a carbon dioxide concentration of 5%, of no greater than 0.1%, and a flexural strength of not lower than 20 N/mm². Such properties make for an inorganic board, manufactured in accordance with the below-described production method, that has excellent wind pressure resistance and long-term durability and that can be used as a building board in outer sidings and inner walls. There is no limit on thickness. Preferably, thickness of the inorganic board is 6 to 25 mm, since transport ability, construction ability, productivity and manufacturing costs are yet better in that case.

The inorganic board of the present invention, preferably, contains the cement and the siliceous material at a weight ratio ranging from 35:65 to 45:55, and contains 7 to 10 wt % of the woody reinforcement. The rationale for such ranges is that when the weight ratio of cement to siliceous material ranges from 35:65 to 45:55, the hydrothermal reactions during autoclave curing proceed smoothly, the amount of tobermorite produced is large, and the matrix becomes more dense, whereby the obtained inorganic board can exhibit sufficient strength, and a small dimensional change rate. Preferably, the content of the woody reinforcement ranges from 7 to 10 wt %, since a content in excess of 10 wt % may hinder cement hardening, and may cause the obtained inorganic board to have lower strength, while a content less than 7 wt % may prevent the inorganic board from exhibiting sufficient deflection. Preferably, the inorganic board comprises 3 to 5 wt % of mica, since yet better dimensional stability can be achieved thereby.

The inorganic board of the present invention can be produced in accordance with a wet production method.

The production method of the present invention includes a step of producing raw material slurry comprising a cement, a siliceous material and a woody reinforcement; a step of producing laminated mat by laminating sheets formed by dewatering the obtained raw material slurry; and a step of pressing and curing the laminated mat.

The step of producing raw material slurry is accomplished by mixing a cement, a siliceous material and a woody reinforcement. The cement, the siliceous material and the woody reinforcement may be added in a powdered (dry) state, or may be added after having mixed beforehand these raw materials with different water. The solids concentration of the slurry is adjusted to be no greater than 20 wt %. The rationale for setting the solids concentration of the slurry to be no greater than 20 wt % is that when the solids concentration exceeds 20 wt %, dewatering of the slurry takes time, cracks develop readily in the dewatered formed sheet, and sheet forming becomes difficult, among other problems.

The step of producing laminated mat by laminating sheets formed by dewatering the obtained raw material slurry involves separating first the slurry into water and a solid product, using felt, a wire mesh or the like. As a specific dewatering method, for instance, the slurry can be caused to flow down onto felt, to dewater thus the slurry. Alternatively, the slurry can be passed through a wire mesh. The step of producing laminated mat is accomplished by laminating another formed sheet on the obtained formed sheet. The method of laminating the formed sheets may involve, for instance, providing a plurality of devices for producing a formed sheet, along the transport direction of the formed sheet, and laminating the formed sheets produced in each device, or may involve laminating a formed sheet by taking up the formed sheet on a roll, and removing the resulting sheet from the roll once a predetermined thickness is achieved.

The step of pressing and curing the obtained laminated mat is accomplished by pressing the laminated mat at a pressure of 50 kg/cm² or higher, followed by autoclave curing. A textured pattern is formed on the surface of the laminated mat by placing a formboard on or under the laminated mat, during pressing. The autoclave curing conditions include curing for 7 to 15 hours at a temperature ranging from 170 to 200° C., at a pressure of 0.5 MPa or higher.

Examples of the present invention are explained next.

Portland cement, silica sand, woody reinforcement and water were mixed to form a slurry; the slurry was caused to flow down onto a dewatering felt, on which a formed sheet was shaped accompanying dewatering. The formed sheet was laminated by being taken up on a roll, and the obtained laminated mat by separating from the roll was pressed and cured in a autoclave, to produce thereby inorganic boards of Examples 1 to 6 and Comparative examples 1 to 5. Table 1 gives the composition with respect to total solids in the slurry and solids concentration of each raw material in the slurry, as well as the press pressure and autoclave curing temperature. Needle-leaves-tree unbleached kraft pulp having a Canadian freeness of 450 ml was used as the woody reinforcement in the blends of Examples 1, 2 and 4 to 6, and in Comparative examples 1 to 4. Used paper and needle-leaves-tree unbleached kraft pulp having a Canadian freeness of 450 ml were used in the blends Example 3 and Comparative example 5. Mica was included in the blends of Examples 1 and 3 to 6 and in Comparative examples 1 and 3 to 5.

The various obtained inorganic boards of Examples 1 to 6 and Comparative examples 1 to 5 were subjected to measurements of specific gravity, thickness, flexural strength, dimensional change rate upon ten-day moisture desorption at 80° C., dimensional change rate upon seven-day moisture absorption, and seven-day dimensional change rate in an environment having a carbon dioxide concentration of 5%. The results are given in Table 1.

TABLE 1

| | | | Ex. 1 | Ex. 2 | Ex. 3 | Ex. 4 | Ex. 5 | Ex. 6 |
|---|---|---|---|---|---|---|---|---|
| Slurry blend | Portland cement | wt % | 35.6% | 36.8% | 35.6% | 31.2% | 40.1% | 35.6% |
| | Silica sand | wt % | 53.4% | 55.2% | 53.4% | 57.9% | 49.0% | 53.4% |
| | Needle-leaves-tree | wt % | 8.0% | 8.0% | 6.0% | 8.0% | 8.0% | 8.0% |
| | unbleached kraft | | | | | | | |
| | pulp | | | | | | | |
| | Used paper | wt % | 0.0% | 0.0% | 2.0% | 0.0% | 0.0% | 0.0% |
| | Mica | wt % | 3.0% | 0.0% | 3.0% | 3.0% | 3.0% | 3.0% |
| | Sub-total | wt % | 100.0% | 100.0% | 100.0% | 100.0% | 100.0% | 100.0% |
| Production | Slurry solids | wt % | 5% | 5% | 5% | 5% | 5% | 5% |
| conditions | concentration | | | | | | | |
| | Press pressure | kg/cm² | 100 | 100 | 100 | 100 | 100 | 75 |
| | Autoclave curing | ° C. | 180 | 180 | 180 | 180 | 180 | 190 |
| | temperature | | | | | | | |
| Properties | Specific gravity | — | 1.55 | 1.56 | 1.56 | 1.54 | 1.56 | 1.52 |
| | Thickness | mm | 8 | 8 | 8 | 8 | 8 | 8 |
| | Flexural strength | N/mm² | 26.8 | 27.1 | 22.7 | 24.2 | 24.5 | 23.9 |
| | Dimensional change | % | 0.06 | 0.08 | 0.06 | 0.07 | 0.07 | 0.08 |
| | rate upon ten-day | | | | | | | |
| | moisture | | | | | | | |
| | desorption at 80° C. | | | | | | | |
| | Dimensional change | % | 0.06 | 0.06 | 0.06 | 0.07 | 0.07 | 0.07 |
| | rate upon seven-day | | | | | | | |
| | moisture | | | | | | | |
| | absorption | | | | | | | |
| | Seven-day | % | 0.03 | 0.04 | 0.03 | 0.04 | 0.04 | 0.04 |
| | dimensional change | | | | | | | |
| | rate in an | | | | | | | |
| | environment having | | | | | | | |
| | a carbon dioxide | | | | | | | |
| | concentration of 5% | | | | | | | |

| | | | Comp. | Comp. | Comp. | Comp. | Comp. |
|---|---|---|---|---|---|---|---|
| | | | ex. 1 | ex. 2 | ex. 3 | ex. 4 | ex. 5 |
| Slurry blend | Portland cement | wt % | 35.6% | 35.6% | 44.5% | 32.8% | 35.6% |
| | Silica sand | wt % | 53.4% | 53.4% | 44.5% | 49.2% | 53.4% |
| | Needle-leaves-tree | wt % | 8.0% | 11.0% | 8.0% | 8.0% | 0.0% |
| | unbleached kraft | | | | | | |
| | pulp | | | | | | |
| | Used paper | wt % | 0.0% | 0.0% | 0.0% | 0.0% | 8.0% |
| | Mica | wt % | 3.0% | 0.0% | 3.0% | 10.0% | 3.0% |
| | Sub-total | wt % | 100.0% | 100.0% | 100.0% | 100.0% | 100.0% |
| Production | Slurry solids | wt % | 5% | 5% | 5% | 5% | 5% |
| conditions | concentration | | | | | | |
| | Press pressure | kg/cm² | 40 | 100 | 100 | 100 | 100 |
| | Autoclave curing | ° C. | 100 | 180 | 180 | 180 | 180 |
| | temperature | | | | | | |
| Properties | Specific gravity | — | 1.35 | 1.41 | 1.56 | 1.33 | 1.56 |
| | Thickness | mm | 8 | 8 | 8 | 8 | 8 |
| | Flexural strength | N/mm² | 15.3 | 19.0 | 18.4 | 13.5 | 17.8 |
| | Dimensional change | % | 0.15 | 0.14 | 0.10 | 0.12 | 0.06 |
| | rate upon ten-day | | | | | | |
| | moisture | | | | | | |
| | desorption at 80° C. | | | | | | |
| | Dimensional change | % | 0.11 | 0.11 | 0.08 | 0.11 | 0.06 |
| | rate upon seven-day | | | | | | |
| | moisture | | | | | | |
| | absorption | | | | | | |
| | Seven-day | % | 0.13 | 0.12 | 0.08 | 0.11 | 0.03 |
| | dimensional change | | | | | | |
| | rate in an | | | | | | |
| | environment having | | | | | | |
| | a carbon dioxide | | | | | | |
| | concentration of 5% | | | | | | |

The inorganic boards of Examples 1 to 6, in which the press pressure was higher than 50 kg/cm² and the autoclave curing temperature 170° C. or higher, had a specific gravity ranging from 1.5 to 1.6, and excellent flexural strength, greater than 20 N/mm². All the boards exhibited also excellent dimensional change rate upon ten-day moisture desorption at 80° C., dimensional change rate upon seven-day moisture absorption, seven-day dimensional change rate in an environment having a carbon dioxide concentration of 5%, with values smaller than 0.1% for all the foregoing.

The inorganic board of Comparative example 1, in which the press pressure was 40 kg/cm² and the autoclave curing temperature 100° C., exhibited a low specific gravity, of 1.35, flexural strength lower than 20 N/mm², and dimensional change rate upon ten-day moisture desorption at 80° C., dimensional change rate upon seven-day moisture absorption and seven-day dimensional change rate in an environment having a carbon dioxide concentration of 5% all greater than 0.1%.

The inorganic board of Comparative example 2, in which the press pressure was 100 kg/cm², the autoclave curing temperature 180° C., and the content of needle-leaves-tree unbleached kraft pulp 11 wt %, exhibited a specific gravity of 1.41, a flexural strength lower than 20 N/mm², and a dimensional change rate upon ten-day moisture desorption at 80° C., a dimensional change rate upon seven-day moisture absorption and a seven-day dimensional change rate in an environment having a carbon dioxide concentration of 5% all greater than 0.1%.

The inorganic board in Comparative example 3, in which the press pressure was 100 kg/cm², the autoclave curing temperature 180° C., the content of Portland cement 44.5 wt %, and the content of silica sand 44.5%, exhibited a dimensional change rate upon ten-day moisture desorption at 80° C., a dimensional change rate upon seven-day moisture absorption, and a seven-day dimensional change rate in an environment having a carbon dioxide concentration of 5% that were all no greater than 0.1%. However, flexural strength was poor, lower than 18.4 N/mm².

The inorganic board of Comparative example 4, in which the press pressure was 100 kg/cm², the autoclave curing temperature 180° C., and the content of mica 10 wt %, exhibited a low specific gravity of 1.33, a flexural strength lower than 20 N/mm², and a dimensional change rate upon ten-day moisture desorption at 80° C., a dimensional change rate upon seven-day moisture absorption and a seven-day dimensional change rate in an environment having a carbon dioxide concentration of 5% all greater than 0.1%.

The inorganic board of Comparative example 5, in which the press pressure was 100 kg/cm², the autoclave curing temperature 180° C., the content of used paper 8.0 wt % and the content of mica 3 wt %, exhibited excellent dimensional change rate upon ten-day moisture desorption at 80° C., dimensional change rate upon seven-day moisture absorption and seven-day dimensional change rate in an environment having a carbon dioxide concentration of 5%, being all less than 0.1%. However, the flexural strength of the inorganic board was poor, being lower than 20 N/mm².

An embodiment of the present invention has been explained above, but the present invention is not limited thereto, and may accommodate all manner of variations within the scope of the invention as set forth in the appended claims.

As explained above, the present invention succeeds in providing an inorganic board having excellent wind pressure resistance and long-term durability, and a production method of such an inorganic board.

What is claimed is:

1. An inorganic board obtained by laminating layers comprising a cement, a siliceous material and a woody reinforcement,
wherein the inorganic board has a specific gravity ranging from 1.5 to 2.0; a dimensional change rate upon ten-day moisture desorption at 80° C. of no greater than 0.1%; a dimensional change rate upon seven-day moisture absorption of no greater than 0.1%; a seven-day dimensional change rate, in an environment having a carbon dioxide concentration of 5%, of no greater than 0.1%; and a flexural strength of not lower than 20 N/mm².

2. The inorganic board according to claim 1,
wherein a weight ratio of the content of the cement and the siliceous material ranges from 35:65 to 45:55; and
the content of the woody reinforcement ranges from 7 to 10 wt %.

3. The inorganic board according to claim 1,
wherein the woody reinforcement is a needle-leaves-tree pulp.

4. The inorganic board according to claim 1,
wherein the woody reinforcement is a needle-leaves-tree pulp and used paper.

5. The inorganic board according to claim 1, further comprising 3 to 5 wt % of mica.

6. A method for producing inorganic board, comprising the steps of:
producing raw material slurry comprising a cement, a siliceous material and a woody reinforcement;
producing laminated mat by laminating sheets formed by dewatering the obtained raw material slurry; and
pressing and curing the laminated mat,
wherein a press pressure in the pressing and curing step is not lower than 50 kg/cm², and curing is performed at 170 to 200° C. in an autoclave.

7. The method for producing inorganic board according to claim 6,
wherein in the step of producing laminated mat, the laminated mat is produced by laminating sheets obtained by pressure-dewatering the raw material slurry.

8. The method for producing inorganic board according to claim 6,
wherein in the step of producing raw material slurry, a weight ratio of the cement and the siliceous material in the raw material slurry ranges from 35:65 to 45:55, and the content of the woody reinforcement ranges from 7 to 10 wt % with respect to solids of the raw material slurry.

9. The method for producing inorganic board according to claim 6,
wherein the woody reinforcement in the raw material slurry used in the step of producing raw material slurry is a needle-leaves-tree pulp.

10. The method for producing inorganic board according to claim 6,
wherein the woody reinforcement in the raw material slurry used in the step of producing raw material slurry is a needle-leaves-tree pulp and used paper.

11. The method for producing inorganic board according to claim 6,
wherein in the step of producing raw material slurry, 3 to 5 wt % of mica, on a solids basis, is incorporated into the raw material slurry.
